(19) United States
(12) Patent Application Publication
(10) Pub. No.: US 2002/0070055 A1
(43) Pub. Date: Jun. 13, 2002

(54) Transcription system for use with flip charts

(76) Inventors: Wilfred Collier, Peabody, CA (US); Kevin Desmarais, Medford, MA (US); Jeffrey Millard, Marina, GA (US); Curt Nauseda, Concord, MA (US); Hector Padilla, Medford, MA (US)

Correspondence Address: WILSON SONSINI GOODRICH & ROSATI, 650 PAGE MILL ROAD, PALO ALTO, CA, 943041050

(21) Appl. No.: 09/877,417

(22) Filed: Jun. 7, 2001

Related U.S. Application Data
(60) Provisional application No. 60/210,663, filed on Jun. 9, 2000.

(51) Int. Cl. G06K 11/06

(52) U.S. Cl. 178/18.01

(57) ABSTRACT

A flip chart transcription system, components thereof and kits thereof are provided, a kit of which comprises: a transcription system receiver housing comprising at least first and second airborne signal receivers which receive airborne signals from a stylus from adjacent a writing surface of a flip chart and employ the airborne signals to determine a position of the stylus relative to the flip chart; and a mounting bracket for mounting the transcription system receiver housing relative to a flip chart.

### RELATIONSHIP TO COPENDING APPLICATION

This application is a continuation-in-part of U.S. Provisional Application Serial No. 60/210,663, filed Jun. 9, 2000, which is incorporated herein by reference in its entirety.

### BACKGROUND OF THE INVENTION

1. Field of the Invention

The present invention relates to an ultrasound transcription system and more particularly to an ultrasound transcription system adapted for use with flip charts.

2. Description of Related Art

Ultrasound has been used in a variety of positioning systems. These systems typically involve the transmission of an ultrasound signal and the calculation of the time of flight of the signal. Recently, Virtual Ink, Inc. introduced an ultrasound transcription system, MIMIO™ which is described in detail in PCT Application Serial No. PCT/US99/09879 which is incorporated herein by reference in its entirety. Electronics For Imaging, Inc. also recently introduced an ultrasound transcription system called EBEAM™.

### SUMMARY OF THE INVENTION

A receiver for use in a flip chart transcription system is provided comprising: a transcription system receiver housing comprising at least first and second airborne signal receivers which receive airborne signals from a stylus from adjacent a writing surface of a flip chart and employ the airborne signals to determine a position of the stylus relative to the flip chart. The transcription system receiver housing may further comprise one or more user activatable controls which cause the transcription system to perform one or more functions when activated. For example, a user activatable control may cause the transcription system to print a recorded image of what has been written on the flip chart when activated. A user activatable control may cause the transcription system to identify a page of the flip chart to which the transcription system is synchronized when activated. A user activatable control may change a page of the flip chart to which the transcription system is synchronized when activated. The transcription system receiver housing may also further comprise forward and reverse user activatable controls which changes a page of the flip chart to which the transcription system is synchronized in the forward and reverse directions when activated. A user activatable control may also alter a size of an image of transcribed information in a display operably connected to the transcription system when activated. The transcription system receiver housing may optionally further comprise a display which identifies a page of the flip chart to which the transcription system is synchronized when activated.

A mounting bracket for use in combination with a flip chart transcription system is also provided. In one embodiment, the mounting bracket positions the transcription system receiver housing outside of a lateral footprint of the flip chart. In another embodiment, the transcription system has a dead zone where the ability of the transcription system to determine a position of the stylus is imprecise, the mounting bracket positioning the transcription system receiver housing so that the dead zone of the transcription system is outside of a lateral footprint of the flip chart. In yet another embodiment, the mounting bracket orients first and second signal receivers of the transcription system relative to an edge of the flip chart such that a line intersecting the first and second signal receivers is at an angle of at least 10 degrees relative to a line parallel to the edge of the flip chart.

According to any of the preceding mounting bracket embodiments, the mounting bracket preferably positions the transcription system receiver housing relative to the flip chart so that pages of the flip chart can be flipped without moving the transcription system receiver housing.

Also according to any of the preceding mounting bracket embodiments, the mounting bracket preferably positions the transcription system receiver housing relative to the flip chart such that the angle between the line intersecting the first and second signal receivers and the line parallel to the edge of the flip chart is at least 10 degrees, preferably at least 15 degrees, and is also preferably less than 30 degrees, more preferably less than 25 degrees.

A kit for a flip chart transcription system is also provided comprising: a transcription system receiver housing comprising at least first and second airborne signal receivers which receive airborne signals from a stylus from adjacent a writing Surface of a flip chart and employ the airborne signals to determine a position of the stylus relative to the flip chart; and a mounting bracket for mounting the transcription system receiver housing relative to a flip chart; wherein the mounting bracket positions the transcription system receiver housing outside of a lateral footprint of the flip chart.

A kit for a flip chart transcription system is also provided comprising: a transcription system receiver housing comprising at least first and second airborne signal receivers which receive airborne signals from a stylus from adjacent a writing surface of a flip chart and employ the airborne signals to determine a position of the stylus relative to the flip chart; and a mounting bracket for mounting the transcription system receiver housing relative to a flip chart; wherein the transcription system has a dead zone adjacent the first and second signal receivers where the ability of the transcription system to determine a position of the stylus is imprecise, the mounting bracket positioning the transcription system receiver housing so that the dead zone of the transcription system is outside of a lateral footprint of the flip chart.

A kit for a flip chart transcription system is also provided comprising: a transcription system receiver housing comprising at least first and second airborne signal receivers which receive airborne signals from a stylus from adjacent a writing surface of a flip chart and employ the airborne signals to determine a position of the stylus relative to the flip chart; and a mounting bracket for mounting the transcription system receiver housing relative to a flip chart; wherein the mounting bracket orients the first and second signal receivers of the transcription system relative to an edge of the flip chart such that a line intersecting the first and second signal receivers is at an angle of at least 10 degrees relative to a line parallel to the edge of the flip chart.

According to any of the preceding kit embodiments, the transcription system receiver housing may further comprise one or more user activatable controls which cause the transcription system to perform one or more functions when activated. For example, a user activatable control may cause the transcription system to print a recorded image of what has been written on the flip chart when activated. A user activatable control may cause the transcription system to identify a page of the flip chart to which the transcription system is synchronized when activated. A user activatable control may change a page of the flip chart to which the transcription system is synchronized when activated. The transcription system receiver housing may also further comprise forward and reverse user activatable controls which changes a page of the flip chart to which the transcription system is synchronized in the forward and reverse directions when activated. A user activatable control may also alter a size of an image of transcribed information in a display operably connected to the transcription system when activated. The transcription system receiver housing may optionally further comprise a display which identifies a page of the flip chart to which the transcription system is synchronized when activated.

According to any of the preceding kit embodiments, the mounting bracket preferably positions the transcription system receiver housing relative to the flip chart so that pages of the flip chart can be flipped without moving the transcription system receiver housing.

Also according to any of the preceding kit embodiments, the mounting bracket preferably positions the transcription system receiver housing relative to the flip chart such that the angle between the line intersecting the first and second signal receivers and the line parallel to the edge of the flip chart is at least 10 degrees, preferably at least 15 degrees, and is also preferably less than 30 degrees, more preferably less than 25 degrees.

### BRIEF DESCRIPTION OF THE FIGURES

FIG. 1A illustrates a top down view of a transcription system.

FIG. 1B illustrates a front view of the transcription system.

FIG. 1C illustrates a bottom up view of the transcription system.

FIG. 1D illustrates a rear view of the transcription system.

FIG. 2 illustrates a top down view of a mounted bracket.

FIG. 3A illustrates a top down view of the transcription system with the mounting bracket attached.

FIG. 3B illustrates a bottom up view of the transcription system with the mounting bracket attached.

FIG. 3C illustrates a front side view of the transcription system with the mounting bracket attached.

FIG. 3D illustrates a side view of the transcription system with the mounting bracket attached.

FIG. 4A illustrates a top down view of the transcription system and mounting bracket attached to the cardboard backing of a flipchart.

FIG. 4B illustrates a top down view of the transcription system and mounting bracket with paper from the flipchart covering the mounting bracket clip.

FIG. 4C illustrates a side view of the transcription system and mounting bracket attached to the cardboard backing of a flipchart.

FIG. 4D illustrates a front side view of the transcription system and mounting bracket attached to the cardboard backing of a flipchart.

FIG. 5 illustrates an embodiment where multiple transcription systems are used in combination with multiple flip charts at the same time.

FIG. 6 shows a sequence of writing across multiple pages of different flip charts over time.

FIG. 7 illustrates an embodiment of a mounting bracket for mounting a stylus relative to a flip chart.

FIG. 8 illustrates a sequence for mounting a stylus mounting bracket to a flip chart and mounting a stylus to the stylus mounting bracket.

### DETAILED DESCRIPTION

Existing transcription systems have been designed primarily for writing surfaces such as whiteboards, blackboards, and desktops. In addition to whiteboards and blackboards, flip charts are commonly used in presentations and meetings to facilitate the communication of ideas. The present invention relates to a transcription system designed for use with flip charts that complement how people currently utilize flip charts.

The transcription system of the present invention is a member of a class of transcription systems which includes two or more signal receivers which receive airborne signals from a stylus when that stylus is positioned adjacent a writing surface. The transcription system determines the position of the stylus relative to the two or more signal receivers based on the signals from the stylus to the two or more signal receivers.

The signal receivers are preferably ultrasound signal receivers but may also be other form of airborne signal receivers such as optical and radiofrequency signals. In one particular embodiment, the signal receivers are point signal receivers, such as a cylindrical ultrasound transducer. By determining the position of the stylus at different times, the movement of the stylus relative to the signal receivers can be determined and recorded.

The design and operation of an ultrasound transcription system which may be utilized in the present invention, and its subcomponents (e.g., receivers, transmitters, stylus, software, etc.) is described in detail in PCT Application Serial No. PCT/US99/09879 which is incorporated herein by reference in its entirety. Consistent with that system, the transcription system of the present invention preferably is able to record writing in multiple different colors and is able to capture writing in real time on a stroke by stroke basis.

Flip charts have several features and modes of use which distinguish them from other writing surfaces with which transcription systems have typically been used. For example, flip charts tend to have a smaller available writing space than whiteboards and blackboards, typically less than 4 feet by 4 feet, more typically less than 3 feet by 2 feet. The present invention addresses the reduced workspace of flip charts by reducing the amount of lateral footprint of the transcription system that is positioned over the flip chart so that the flip chart's writing space can be effectively utilized. More preferably, the lateral footprint of the transcription system does not overlap with the lateral footprint of the flip chart's writing space. This is accomplished, for example, by having the receivers of the transcription system be positioned outside of the perimeter of the flip chart.

Transcription systems such as ultrasound systems can have difficulty effectively recording writing which is performed too adjacent one or both of the system's signal receivers. According to the present invention, the writing area on the flip chart which can be recorded by the transcription system is increased by arranging how the transcription system is mounted relative to the flip chart so that the “dead zone” of the transcription system adjacent the system's signal receivers is positioned off the flip chart's writing surface. As a result, a larger portion, if not all of the flip chart's writing surface can be recorded by the transcription system. This is accomplished according to the present invention by positioning the transcription system receivers a distance away from an edge of the flip chart and at an angle relative to the edge of the flip chart. The angle between a line intersecting the signal receivers of the transcription system and the edge of the flip chart is preferably at least 10 degrees, preferably at least 15 degrees and more preferably about 20 degrees. The angle of the receivers relative to the edge of the flip chart is also preferably less than 30 degrees and more preferably less than 25 degrees.

A further feature which distinguishes flip charts from other writing surfaces is the ability of a flip chart to serve as multiple writing surfaces. Specifically, since a flip chart is essentially a large pad of paper, one is able to write on different pages of the pad of paper. It is thus desirable for the transcription system to be designed so that the top page of the flip chart can be changed readily (removed or flipped) without interference with the transcription system. The positioning of the transcription system outside of the lateral footprint of the flip chart enables one to change pages readily without interfering with the mounting or operation of the flip chart. As a result, it is unnecessary to move the transcription system relative to the flip chart in order to change pages.

It is also desirable for the transcription system to be designed so that the transcription system can effectively track writing on multiple pages at the same time in situations where a person writes on a first page, flips to and writes on a second page, and then flips back to the first page and writes on the first page. The present invention relates to controls mounted on the transcription system which allows a user to synchronize writing on different pages with how that writing is recorded.

These and other features of the present invention will now be described in greater detail.

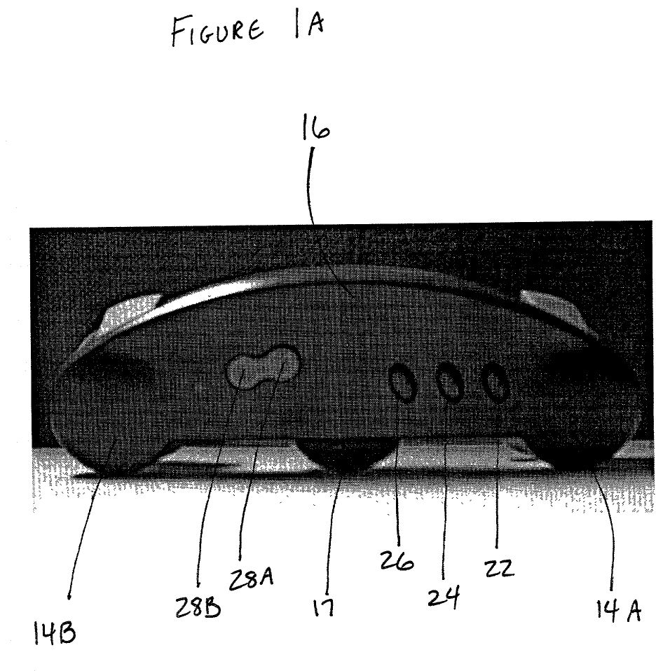

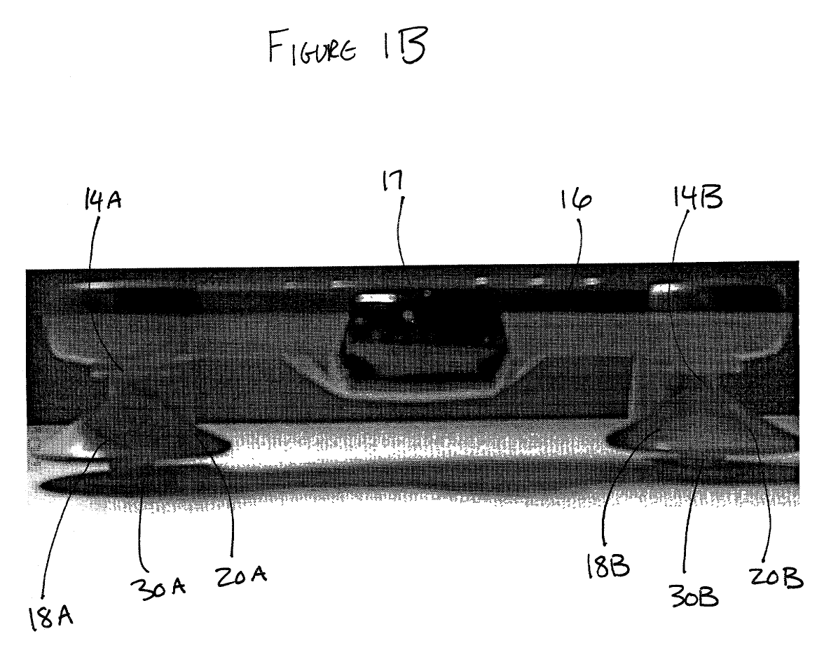

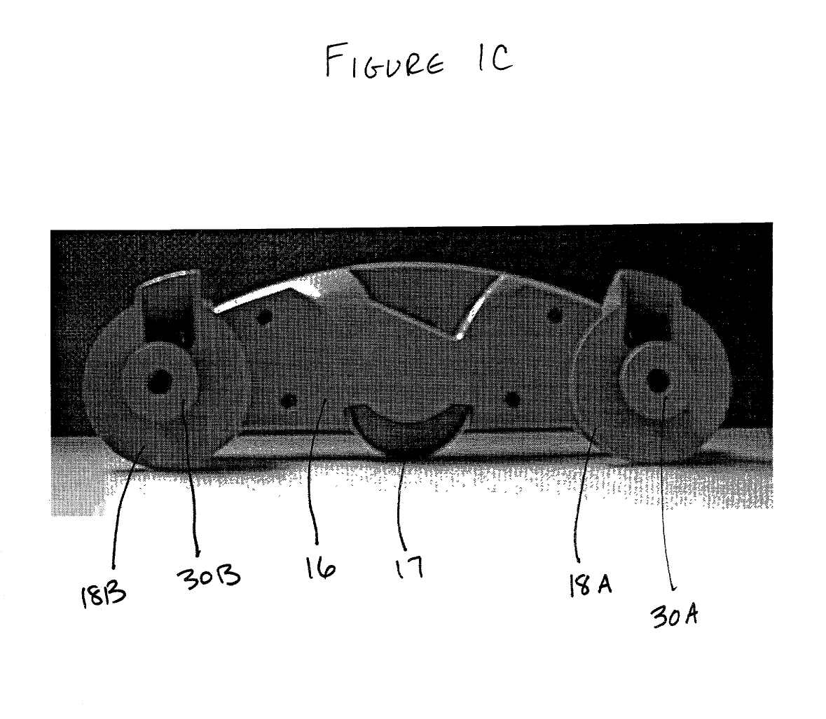

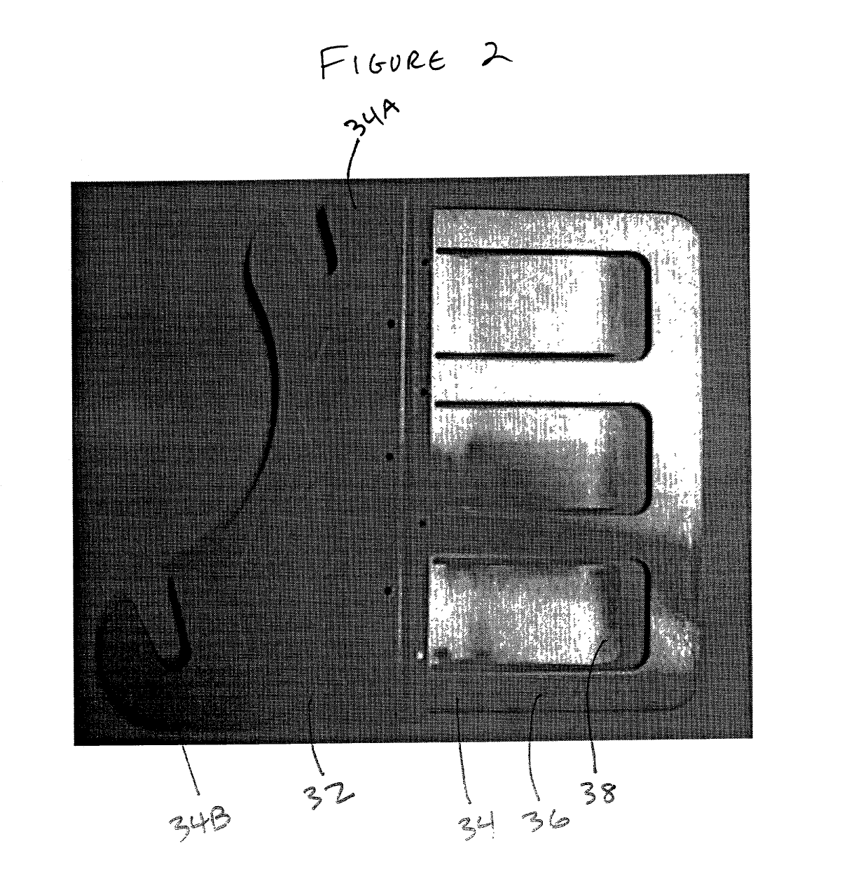

FIG. 1A illustrates a top down view of a transcription system according to the present invention. FIG. 1B illustrates a front view of the transcription system. As illustrated in FIGS. 1A and 1B, the transcription system 12 includes first and second ultrasound signal receivers 14A, 14B spaced apart by a member 16. It is noted that other types of airborne signal receivers may be employed without departing from the present invention.

Positioned between the ultrasound signal receivers 14A, 14B is an infrared receiver 17 for receiving IR signals indicating when ultrasound position signals are sent from a stylus (not shown) which is being used to write on the flip chart. The stylus includes an ultrasound transmitter for transmitting ultrasound position signals and an IR transmitter for transmitting an IR timing signal.

Illustrated below the ultrasound signal receivers 14A, 14B in FIG. 1B are signal focussing elements 18A, 18B which having reflecting surfaces 20A, 20B which are shaped and oriented relative to the signal receivers to reflect the position signals from the stylus onto the signal receivers. As will be explained in more detail herein, the height of the writing surface relative to the signal receivers and the signal focussing elements varies depending on the amount of paper on the flip chart. The reflective surface of a signal focussing element is preferably shaped so that position signals travelling parallel across the writing surface from the stylus are effectively reflected to the signal receivers regardless of the thickness of the flip chart. Hence, position signals travelling parallel to the writing surface and contacting a signal focussing element 10 mm, 20 mm, or 30 mm above the base of the signal focussing element will all be directed to the signal receiver.

As illustrated in FIG. 1A, the transcription system may include one or more user activatable controls. These controls are designed to reduce and optionally eliminate the need for the user to control the transcription system with anything other than the user activatable controls.

The print button 22 causes the current page to be printed. The information button 24 identifies the current page that the software is writing to. This information may be provided by showing a number or having the transcription system speak a number. This feature is useful for synching the transcription system software with the flip chart. For example, this button will tell the user what page writing is being recorded to by the software so that the user can instruct the software to change pages if necessary. The maximize screen button 26 brings a window displaying the current page of writing to the front of a display operably connected to the transcription system. Optionally, the maximize screen button 26 can instruct the software to cycle between multiple states, such as maximize, minimize, and restore.

The forward and reverse toggle buttons 28A, 28B serve to help the transcription system simulate how flip charts are typically used. When one uses a flip chart, one typically writes on a first sheet, then a second, then a third, etc. The advantage of a flip chart is that it is possible to flip back to a prior page, write something, and then flip to another page. The forward and reverse toggle buttons 28A, 28B allow the user while adjacent the flip chart to synchronize the transcription system with the particular sheet that the user is writing on. Hence, if a user writes on a first sheet and then goes to the second sheet, the user taps the forward toggle button 28A. If a user goes to a third sheet, the user taps on the forward toggle button 28A again. If the user then wants to write on the first sheet, the user flips back two sheets and hits the reverse toggle button 28B twice, thereby synchronizing the transcription system with the page on which the user wishes to write.

FIG. 1B also illustrates a pair of mounting legs 30A, 30B which may be used to mount the transcription system on a mounting bracket. Different mechanisms for mounting the transcription system to a mounting bracket may also be devised and are intended to fall within the scope of the present invention.

FIG. 1C illustrates a bottom up view of the transcription system which clearly shows a pair of mounting legs 30A, 30B which may be used to mount the transcription system on a mounting bracket.

FIG. 1D illustrates a rear view of the transcription system. As can be seen, the transcription system includes a signal port 46 for communicating data to and from a computer, a network or some other device including a microprocessor. The signal ports may include serial ports, USB ports, network ports, firewire ports, wireless ports and any other signal ports which may be used to communicate signals to and from the transcription system, whether wired or wireless. In one embodiment, the transcription system receiver housing comprises a signal port which allows the transcription system to interface with DIRECTPRINT or some other mechanism to support printing from the transcription system without the need of a computer.

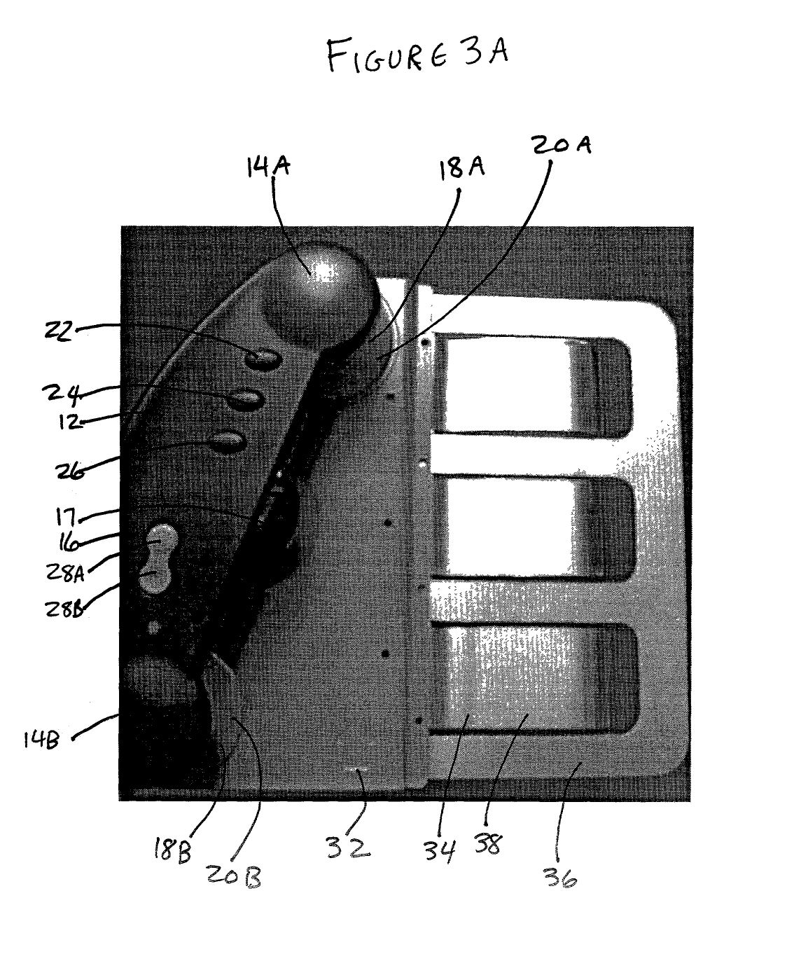

FIG. 2 illustrates a top down view of a mounting bracket 32 that may be used in combination with the transcription system to mount the transcription system onto a flip chart. As illustrated, the mounted bracket 32 includes two slots 34A, 34B into which the mounting legs 30A, 30B of the transcription system may be placed. Other mechanisms for mounting the transcription system to the mounting bracket may also be devised and are intended to fall within the scope of the present invention. The mounted bracket 32 further includes a clip 34 having rear 36 and forward 38 clipping members for attaching the mounted bracket 32 to a flip chart. Other mechanisms for mounting the mounting bracket to a flip chart may also be devised and are intended to fall within the scope of the present invention.

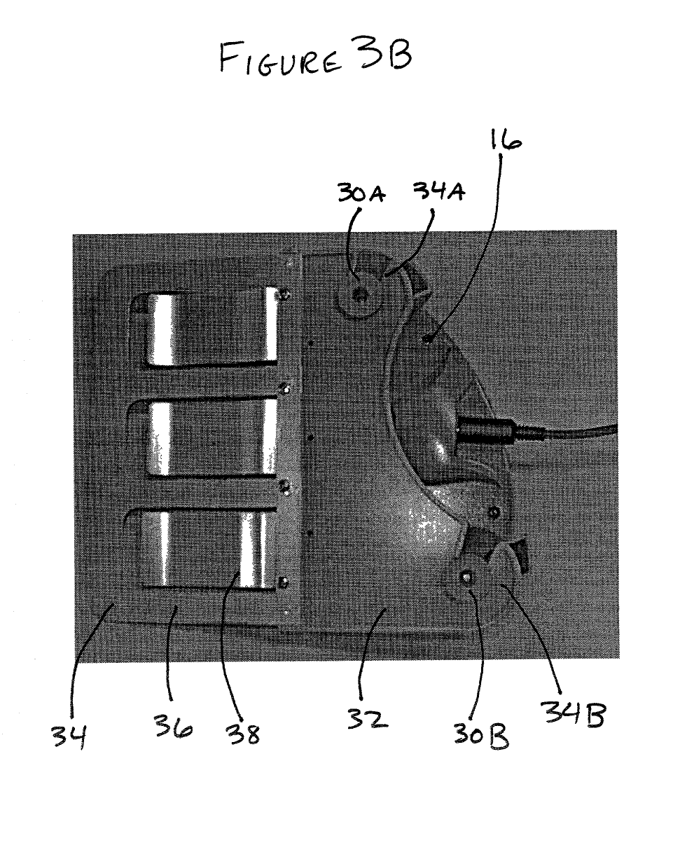

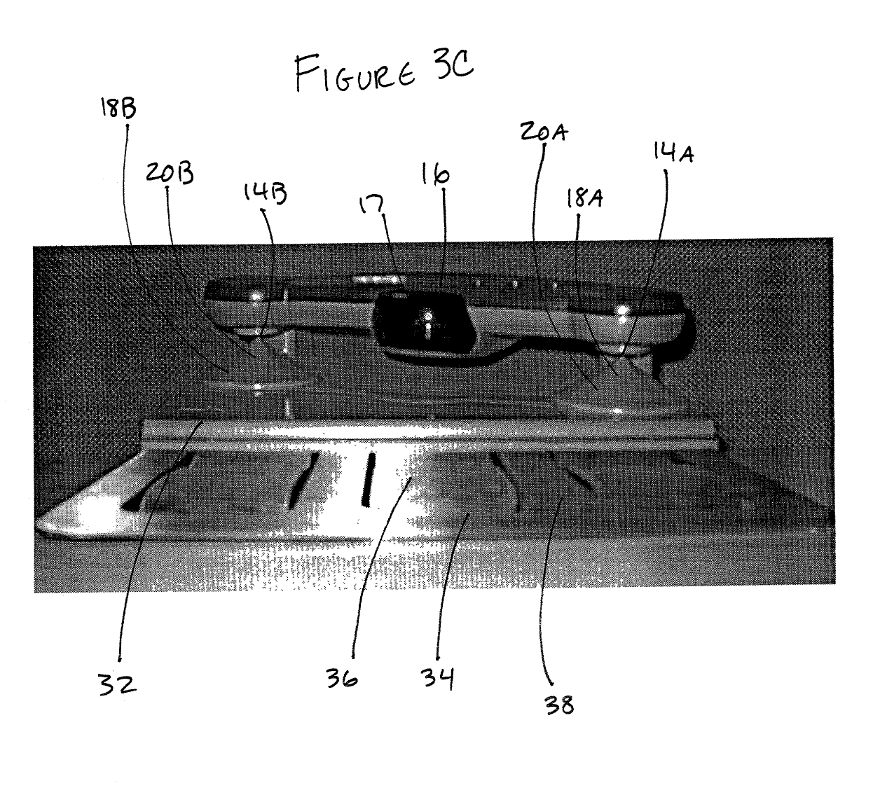

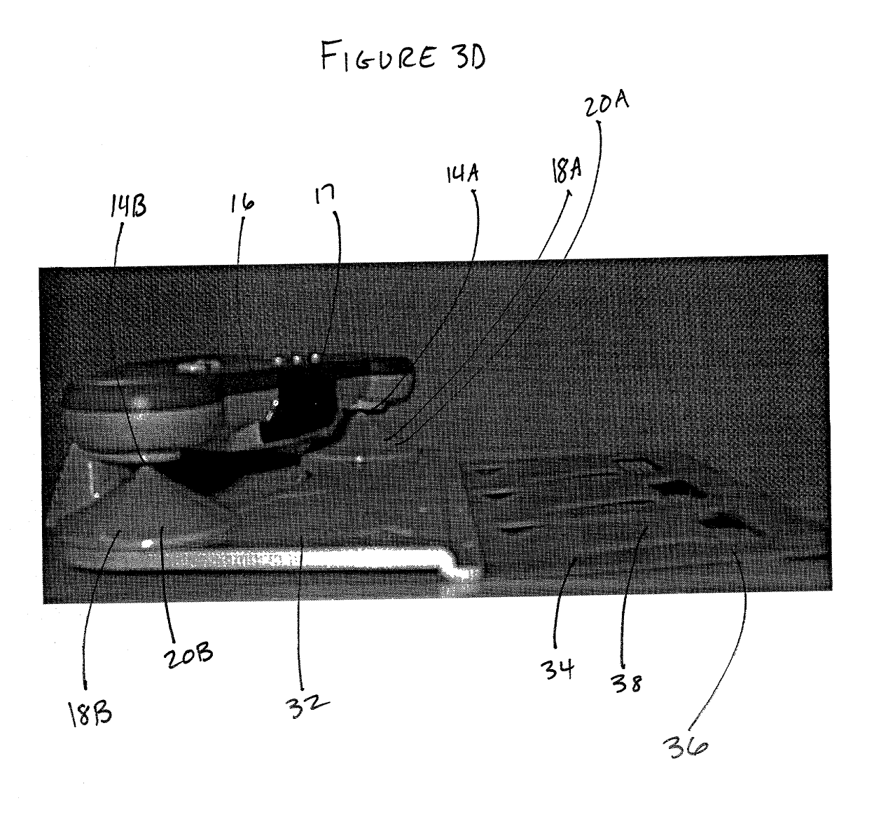

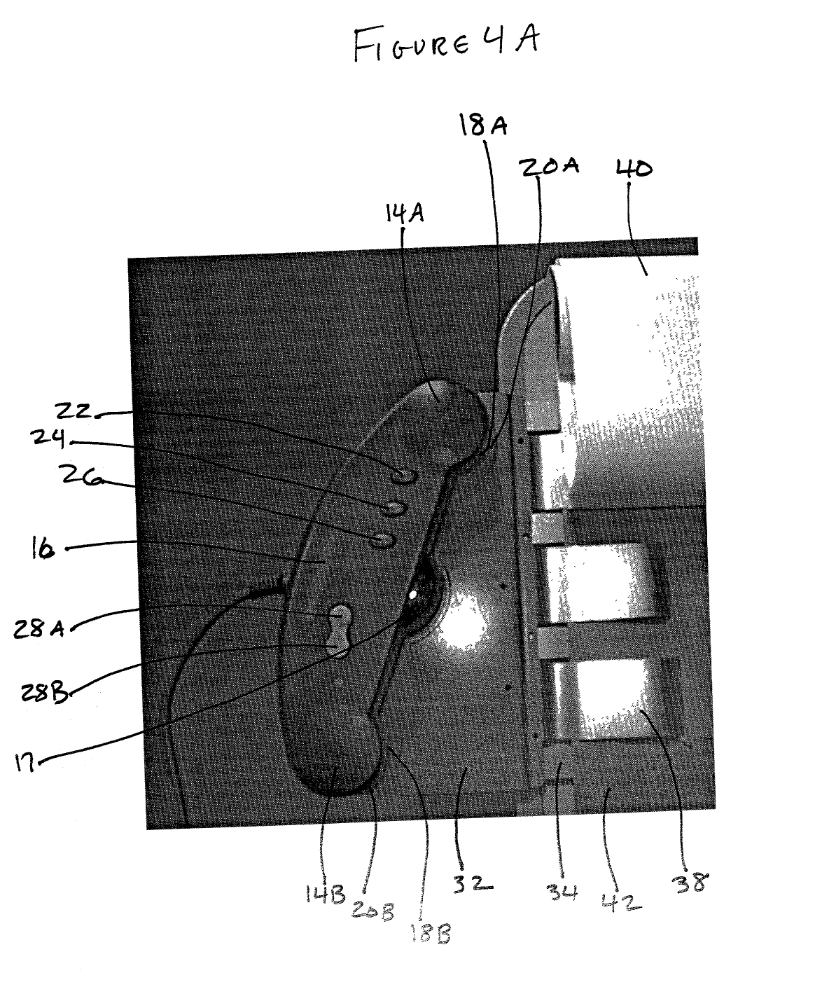

FIG. 3A illustrates a top down view of the transcription system with the mounting bracket attached. FIG. 3B illustrates a bottom up view of the transcription system with the mounting bracket attached. FIG. 3C illustrates a front side view of the transcription system with the mounting bracket attached. FIG. 3D illustrates a rear view of the transcription system with the mounting bracket attached.

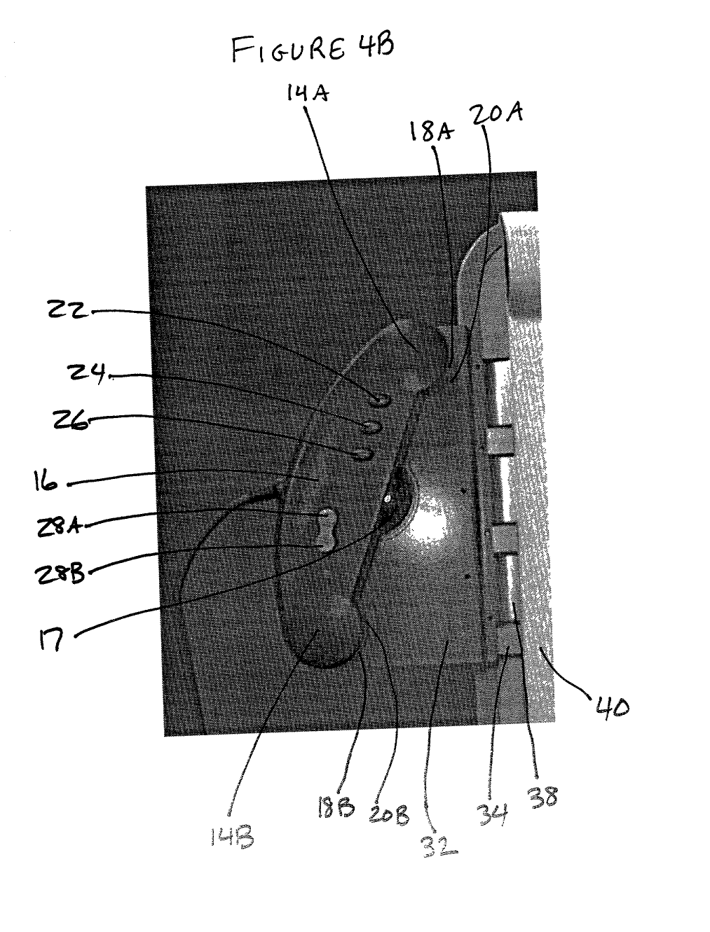

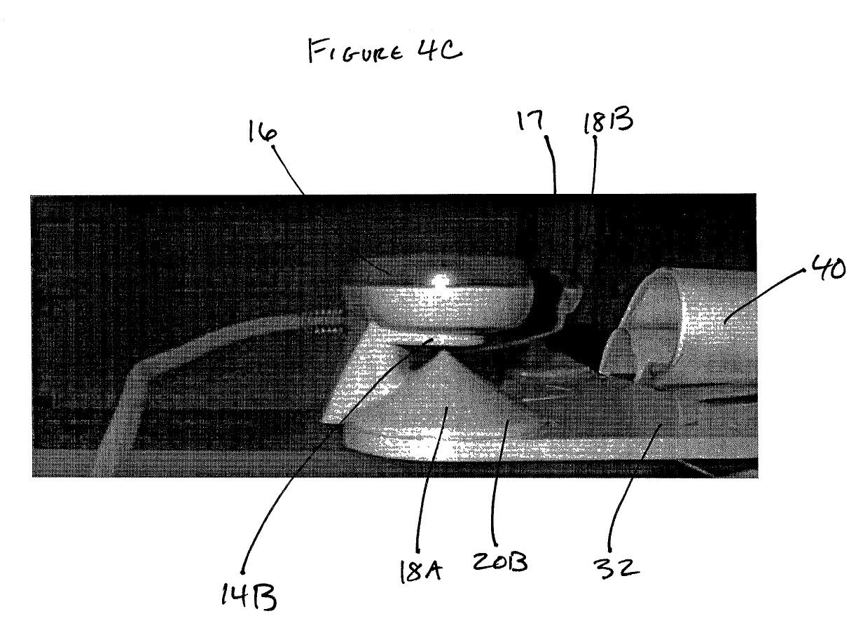

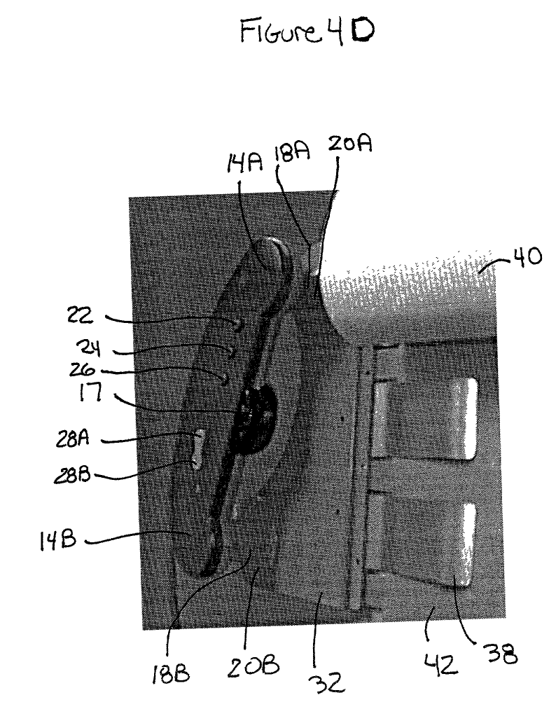

FIG. 4A illustrates a top down view of the transcription system 10 and mounting bracket 32 attached to a flip chart 40. As can be seen, the rear 36 and forward 38 clipping members of the clip 34 are attached to the cardboard backing 42 of the flip chart 40. It is noted that the clipping members of the clip 34 may also be readily attached to other portions of the flip chart 40 including the pages of the flip chart.

FIG. 4B illustrates a top down view of the transcription system and mounting bracket with paper from the flipchart covering the mounting bracket clip. As can be seen in FIGS. 4A and 4B, the transcription system 10 is positioned outside the lateral footprint of the flip chart so that the pages of the flip chart can be flipped without having to move the transcription system.

Time of flight transcription systems typically have a dead zone adjacent the signal receivers where the transcription system does not accurately track the position of the stylus. As also illustrated in FIGS. 4A and 4B, the transcription system is positioned away from and angled relative to an edge of the flip chart. This is done so that the dead zone of the transcription system is outside of the footprint of the flip chart. The angle between a line intersecting the signal receivers of the transcription system and the edge of the flip chart is preferably at least 10 degrees, preferably at least 15 degrees and more preferably about 20 degrees. The angle is also preferably less than 30 degrees and more preferably less than 25 degrees.

FIG. 4C illustrates a side view of the transcription system and mounting bracket attached to the cardboard backing of a flipchart. FIG. 4D illustrates a front side view of the transcription system and mounting bracket attached to the cardboard backing of a flipchart. As can be seen in FIGS. 4C and 4D, the signal receivers 16A, 16B are positioned above the plane of the writing surface. The height of the plane of the writing surface relative to the signal receivers 16A, 16B will vary depending upon how much paper is on the flip chart. As can be seen from this side view, the reflecting surfaces 20A, 20B of the signal focussing elements 18A, 18B serve to direct position signals to the signal receivers independent of the amount of paper on the flip chart.

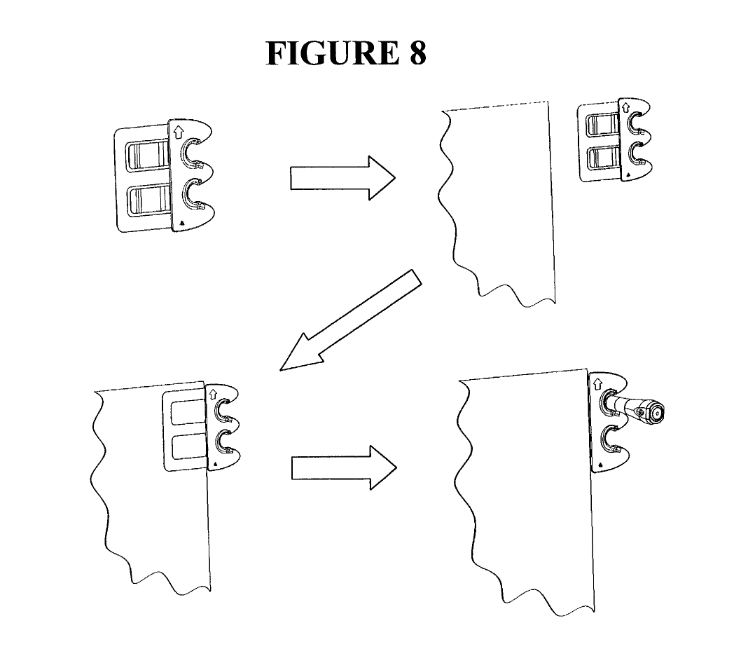

FIG. 7 illustrates a pen mounting bracket 62 that may be used to mount a stylus for use with the transcription system onto a flip chart. As can be seen, the pen mounting bracket 62 comprises a clip 64 with rear 66 and forward 68 clipping members for attaching the pen mounting bracket 62 to a flip chart. It should be understood that other mechanisms for mounting the pen mounting bracket 62 to a flip chart may also be used.

The pen mounting bracket 62 also comprises one or more slots into which stylus may be positioned. FIG. 7 shows two slots 70A, 70B. The slots preferably include supporting material 72 lining a portion of the perimeter of the slots for supporting the stylus within the mounting bracket.

FIG. 8 illustrates a sequence for mounting a stylus mounting bracket to a flip chart and mounting a stylus to the stylus mounting bracket. As can be seen, the stylus, when mounted, is held approximately perpendicular to the plane of the flip chart. Because the flip chart is typically positioned vertically, this means that the stylus is maintained in an approximately horizontal position when mounted. This is a desirable orientation for a pen positioned within the stylus so that media in the pen does not either travel out the tip if the pen is pointed down for a prolonged period of time and does not travel to the rear of the pen if the pen is pointed up for a prolonged period of time such that the pen tip dries out.

In addition to providing the core software functions of MIMIO™ such as those described in detail in PCT Application Serial No. PCT/US99/09879, the transcription system provides several additional software functions which render the transcription system of the present invention well suited for use with flip charts. For example, the transcription system of the present invention includes (or has operably associated with it) computer executable logic that enables a user to record writing that is performed across multiple different pages of a flip chart where the writing is not completely one page to another. More specifically, when a person uses a flip chart, the person does not necessarily write on page 1, then page 2, then page 3, etc., all without writing going back to a previous page to write something.

The present invention further includes computer executable logic operably associated with the transcription system that functions to associate transcription data with a particular page on which the writing is performed. When a user switches pages, the user contacts the forward or reverse toggle button 28A, 28B (or executes some other user executable command) to indicate to the system that the transcription data to follow should be related to a different page. That different page may be a new page, or a page (earlier or later) that has already been written upon. The user thus can synchronize the transcription system with a writing session by telling the system what page the user is writing on. In response to being signaled that the user is going to write on a different page, the computer executable logic associates the transcription data that follows with the page designated to the system by the user.

To further illustrate this feature, a particular embodiment of the operation of the computer executable logic is provided. It is noted that variations on this embodiment can be readily envisioned and are intended to be encompassed within the present invention. The transcription system includes logic for recording writing performed on a page of the flip chart. When the user writes on a first page, the computer executable logic associated with the transcription system creates a file or new page and records transcription data for the writing in the file or new page. When the user goes to the next page, the user presses the forward toggle button 28A. In response to receiving a signal indicating the depression of the forward toggle button 28A, computer executable logic associated with the transcription system creates a new file or page within the same file in which transcription data may be recorded. As the user writes on additional pages, the user can use the forward toggle button 28A to request the creation of additional files or pages within the same file. When a user decides to go from writing on a given page (e.g., page 3) to another page (e.g., page 2), the user presses the appropriate toggle button 28A, 28B (or other user executable command). This signal is used by the computer executable logic to cause the computer to record transcription data in the file or page associated with the user selected page.

A further feature related to the computer executable logic that functions to associate transcription data with a particular page, is computer executable logic that causes the system to jump to the first or last page of the multiple pages. For example, when a user contacts the forward or reverse toggle button 28A, 28B (or executes some other user executable command) in a particular way (e.g., holding the button down), the logic can cause the system to jump to the first or last page of the multiple pages. This allows a user, for example, to simply push down on toggle button 28A for an extended period of time and then flip the chart to the first page.

A further feature of the transcription system is the ability of the system to record writing, the time that the writing is created, and the page that the writing is created. This allows the system to display the sequence by which writing was created on each page as opposed to only being able to show the final version of a body of writing. When a user is toggling back and forth among a group of pages, the computer executable logic records when writing is created as well as the page with which to associate the writing. In this regard, as a user toggles between different pages, the computer executable logic records the time and page associated with the transcription data so that a time sequence for each page of writing can be recreated. This allows the sequence of writing by a user on a given page of a flip chart to be displayed based on the time data associated with the writing data for that page. It also allows the sequence of writing by a user across multiple pages of a flip chart to be displayed based on the time and page data associated with the writing data.

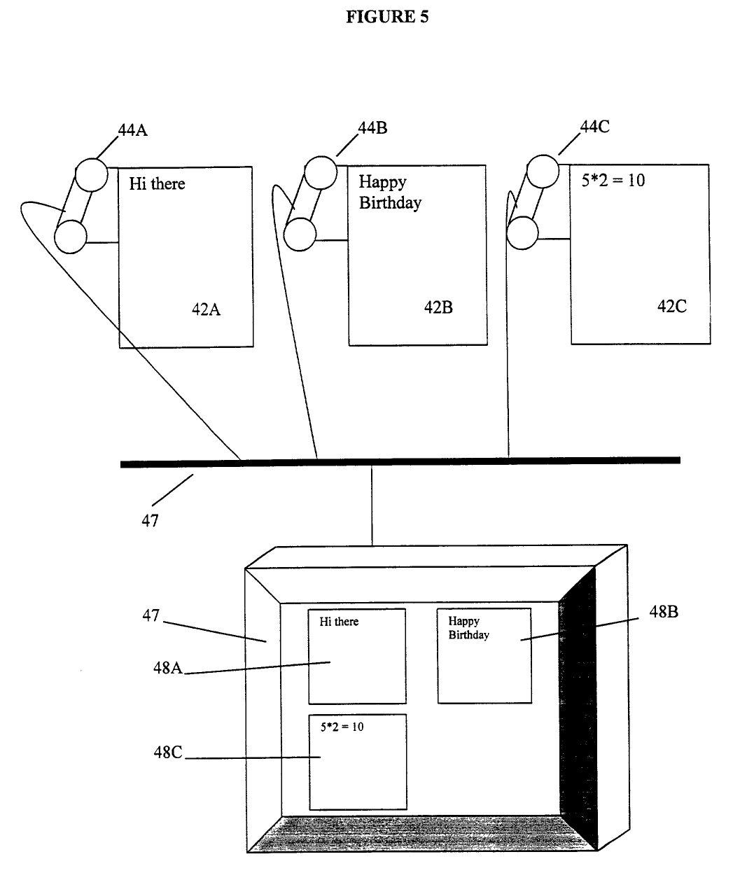

Yet a further feature of the transcription system is the ability of multiple transcription systems to be used in combination with multiple flip charts at the same time. As illustrated in FIG. 5, the present invention enables multiple users to be recording writing on multiple flip charts 42A, 42B, 42C using multiple transcription systems 44A, 44B, 44C operably connected to a same computer 46 having software for operating the transcription system. In this instance, computer 46 is illustrated as a server where the multiple transcription systems 44A, 44B, 44C access the server over a network. As also illustrated in FIG. 5, computer 46 (e.g, a server connected to a network) may be accessed by a client computer 47. As can be seen on the display of the client computer 47, separate images 48A, 48B, 48C from the writing on the different flip charts may be displayed at the same time.

Hosting the transcription system software over the network has several advantages. It allows multiple transcription systems to be connected to the network where the multiple flip charts and multiple transcription systems are situated in the same or different locations and yet be simultaneously accessible by any party connecting to the network.

In relation to using multiple transcription systems in combination with multiple flip charts at the same time, the present invention also relates to computer executable logic associated with the transcription systems that records the time, page, and particular transcription system associated with different portions of writing data as the writing data is recorded. The computer executable logic is able to use the time, page, and transcription system identification data associated with writing data to reconstruct writing sequences. The computer executable logic can be employed to reconstruct writing sequences only for a given page of a flip chart of a given device. Alternatively, the computer executable logic can be employed to reconstruct writing sequences only for pages of a given flip chart of a given device. Alternatively the computer executable logic can be employed to reconstruct writing sequences for multiple devices.

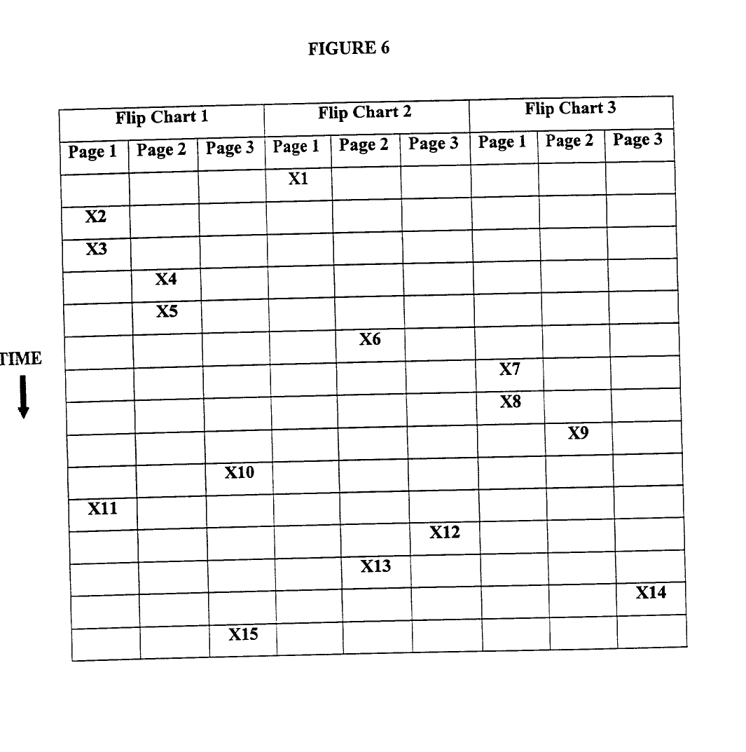

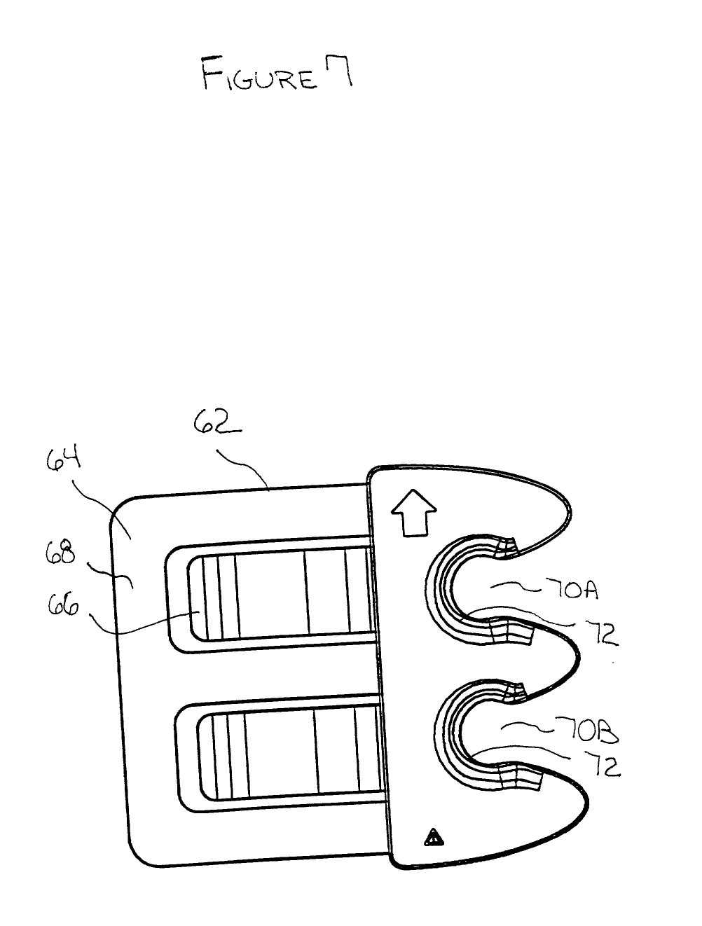

To better illustrate this point, FIG. 6 shows a sequence of writing across multiple pages of different flip charts over time. Writing on each flip chart is recorded by a different transcription device. By associating a transcription system (or flip chart), a page, and time with writing data (the writing data being represented by an X), the computer executable logic is able to reconstruct the time sequence for any given page (e.g., X2, X3 and X11 for Flip Chart 1, page 1), any given flip chart (e.g., X2, X3, X4, X5, X10, X11, and X14 for Flip Chart 1), across the first page of multiple flip charts (e.g., X1, X2, X3, X7 and X8 for Flip Chart 1, page 1+Flip Chart 2, page 1+Flip Chart 3, page 1 ), or across multiple flip charts (e.g., X1-X15 for Flip Chart 1-3).

While the present invention is disclosed by reference to the preferred embodiments and examples detailed above, it is to be understood that these examples are intended in an illustrative rather than limiting sense, as it is contemplated that modifications and combinations will readily occur to those skilled in the art, which modifications and combinations will be within the spirit of the invention and the scope of the appended claims.

What is claimed is:

1. A kit for a flip chart transcription system comprising:
a transcription system receiver housing comprising at least first and second airborne signal receivers which receive airborne signals from a stylus from adjacent a writing surface of a flip chart and employ the airborne signals to determine a position of the stylus relative to the flip chart; and
a mounting bracket for mounting the transcription system receiver housing relative to a flip chart;
wherein the mounting bracket positions the transcription system receiver housing outside of a lateral footprint of the flip chart.

2. A kit according to claim 1 wherein the transcription system receiver housing further comprises one or more user activatable controls which cause the transcription system to perform one or more functions when activated.

3. A kit according to claim 1 wherein the transcription system receiver housing further comprises a user activatable control which causes the transcription system to print a recorded image of what has been written on the flip chart when activated.

4. A kit according to claim 1 wherein the transcription system receiver housing further comprises a user activatable control which causes the transcription system to identify a page of the flip chart to which the transcription system is synchronized when activated.

5. A kit according to claim 1 wherein the transcription system receiver housing further comprises a display which identifies a page of the flip chart to which the transcription system is synchronized.

6. A kit according to claim 1 wherein the transcription system receiver housing further comprises a user activatable control which changes a page of the flip chart to which the transcription system is synchronized when activated.

7. A kit according to claim 1 wherein the transcription system receiver housing further comprises forward and reverse user activatable controls which changes a page of the flip chart to which the transcription system is synchronized in the forward and reverse directions when activated.

8. A kit according to claim 1 wherein the transcription system receiver housing further comprises a user activatable control which alters a size of an image of transcribed information in a display operably connected to the transcription system when activated.

9. A kit according to claim 1 wherein the first and second signal receivers are ultrasound signal receivers.

10. A kit according to claim 1 wherein the first and second signal receivers are optical signal receivers.

11. A kit according to claim 1 wherein the first and second signal receivers are radio frequency signal receivers.

12. A kit according to claim 1 wherein the first and second signal receivers are point receivers.

13. A kit according to claim 1 wherein the transcription system further includes a receiver for receiving timing signals from a stylus.

14. A kit according to claim 1 wherein the mounting bracket positions the transcription system receiver housing so that pages of the flip chart can be flipped without moving the transcription system receiver housing.

15. A kit for a flip chart transcription system comprising:
a transcription system receiver housing comprising at least first and second airborne signal receivers which receive airborne signals from a stylus from adjacent a writing surface of a flip chart and employ the airborne signals to determine a position of the stylus relative to the flip chart; and
a mounting bracket for mounting the transcription system receiver housing relative to a flip chart;
wherein the transcription system has a dead zone adjacent the first and second signal receivers where the ability of the transcription system to determine a position of the stylus is imprecise, the mounting bracket positioning the transcription system receiver housing so that the dead zone of the transcription system is outside of a lateral footprint of the flip chart.

16. A kit according to claim 15 wherein the transcription system receiver housing further comprises one or more user activatable controls which cause the transcription system to perform one or more functions when activated.

17. A kit according to claim 15 wherein the transcription system receiver housing further comprises a user activatable control which causes the transcription system to print a recorded image of what has been written on the flip chart when activated.

18. A kit according to claim 15 wherein the transcription system receiver housing further comprises a user activatable control which causes the transcription system to identify a page of the flip chart to which the transcription system is synchronized when activated.

19. A kit according to claim 15 wherein the transcription system receiver housing further comprises a display which identifies a page of the flip chart to which the transcription system is synchronized.

20. A kit according to claim 15 wherein the transcription system receiver housing further comprises a user activatable control which changes a page of the flip chart to which the transcription system is synchronized when activated.

21. A kit according to claim 15 wherein the transcription system receiver housing further comprises forward and reverse user activatable controls which changes a page of the flip chart to which the transcription system is synchronized in the forward and reverse directions when activated.

22. A kit according to claim 15 wherein the transcription system receiver housing further comprises a user activatable control which alters a size of an image of transcribed information in a display operably connected to the transcription system when activated.

23. A kit according to claim 15 wherein the first and second signal receivers are ultrasound signal receivers.

24. A kit according to claim 15 wherein the first and second signal receivers are optical signal receivers.

25. A kit according to claim 15 wherein the first and second signal receivers are radio frequency signal receivers.

26. A kit according to claim 15 wherein the first and second signal receivers are point receivers.

27. A kit according to claim 15 wherein the transcription system further includes a receiver for receiving timing signals from a stylus.

28. A kit according to claim 15 wherein the mounting bracket positions the transcription system receiver housing so that pages of the flip chart can be flipped without moving the transcription system receiver housing.

29. A kit for a flip chart transcription system comprising:
a transcription system receiver housing comprising at least first and second airborne signal receivers which receive airborne signals from a stylus from adjacent a writing surface of a flip chart and employ the airborne signals to determine a position of the stylus relative to the flip chart; and
a mounting bracket for mounting the transcription system receiver housing relative to a flip chart;
wherein the mounting bracket orients the first and second signal receivers of the transcription system relative to an edge of the flip chart such that a line intersecting the first and second signal receivers is at an angle of at least 10 degrees relative to a line parallel to the edge of the flip chart.

30. A kit according to claim 29 wherein the angle between the line intersecting the first and second signal receivers and the line parallel to the edge of the flip chart is at least 15 degrees.

31. A kit according to claim 29 wherein the angle between the line intersecting the first and second signal receivers and the line parallel to the edge of the flip chart is less than 30 degrees.

32. A kit according to claim 29 wherein the angle between the line intersecting the first and second signal receivers and the line parallel to the edge of the flip chart is less than 25 degrees.

33. A kit according to claim 29 wherein the mounting bracket positions the transcription system receiver housing so that pages of the flip chart can be flipped without moving the transcription system receiver housing.

34. A kit for a flip chart transcription system comprising:
a transcription system receiver housing comprising at least first and second airborne signal receivers which receive airborne signals from a stylus from adjacent a writing surface of a flip chart and employ the airborne signals to determine a position of the stylus relative to the flip chart, the transcription system receiver housing further comprising one or more user activatable controls which cause the transcription system to perform one or more functions when activated; and
a mounting bracket for mounting the transcription system receiver housing relative to a flip chart.

35. A kit according to claim 34 wherein one of the one or more user activatable controls causes the transcription system to print a recorded image of what has been written on the flip chart when activated.

36. A kit according to claim 34 wherein one of the one or more user activatable controls causes the transcription system to identify a page of the flip chart to which the transcription system is synchronized when activated.

37. A kit according to claim 34 wherein one of the one or more user activatable controls identifies a page of the flip chart to which the transcription system is synchronized when activated.

38. A kit according to claim 34 wherein one of the one or more user activatable controls changes a page of the flip chart to which the transcription system is synchronized when activated.

39. A kit according to claim 34 wherein the one or more user activatable controls comprises forward and reverse user activatable controls which changes a page of the flip chart to which the transcription system is synchronized in the forward and reverse directions when activated.

40. A kit according to claim 34 wherein one of the one or more user activatable controls alters a size of an image of transcribed information in a display operably connected to the transcription system when activated.

41. A kit for a flip chart transcription system comprising:
a transcription system receiver housing comprising at least first and second airborne signal receivers which receive airborne signals from a stylus from adjacent a writing surface of a flip chart and employ the airborne signals to determine a position of the stylus relative to the flip chart, the transcription system receiver housing further comprising a display which identifies a page of the flip chart to which the transcription system is synchronized; and
a mounting bracket for mounting the transcription system receiver housing relative to a flip chart.
